(19) United States
(12) Patent Application Publication
(10) Pub. No.: US 2025/0060789 A1
(43) Pub. Date: Feb. 20, 2025

(54) BACK PLATE FOR SUPPORTING FLEXIBLE DISPLAY PANEL AND METHOD FOR MANUFACTURING THE SAME

(71) Applicants: Sang Seob JUNG, Ansan-si, Gyeonggi-do (KR); Yun Koo CHO, Seoul (KR)

(72) Inventor: Sang Seob JUNG, Ansan-si, Gyeonggi-do (KR)

(73) Assignees: Sang Seob JUNG, Ansan-si, Gyeonggi-do (KR); Yun Koo CHO, Seoul (KR)

(21) Appl. No.: 18/724,217

(22) PCT Filed: Feb. 21, 2022
(86) PCT No.: PCT/KR2022/002489

§ 371 Date: Jun. 26, 2024

(30) Foreign Application Priority Data
Dec. 30, 2021 (KR) 10-2021-0193108

(51) Int. Cl. G06F 1/16

(52) U.S. Cl. CPC G06F 1/1656; G06F 1/1652

(57) ABSTRACT

The present invention provides a back plate for supporting a flexible display panel, the back plate comprising: a glass plate member having a pore formed therein; two coating layers covering both surfaces of the glass plate member, respectively; and a filling material filled in the pore and connected to the two coating layers, wherein the glass plate member comprises two non-deformation structure parts arranged to be spaced apart from each other and a deformation structure part arranged between the two non-deformation structure parts and connecting the two non-deformation structure parts, wherein the deformation structure part is formed through a deformation section in the lengthwise direction and is configured to have a mesh shape by through-holes extending through the deformation structure part along the width direction thereof and forming the pore.

### TECHNICAL FIELD

The present invention relates to a flexible display apparatus, and more particularly, to a back plate for supporting a flexible display panel in a flexible display apparatus.

### BACKGROUND ART

Recently, as foldable mobile devices capable of folding and unfolding a display screen have been spotlighted, researches into flexible display apparatuses that can be folded and unfolded and furthermore are rollable, have been briskly carried out. In general, a flexible display apparatus includes a flexible display panel, and a back plate that supports the flexible display panel entirely and maintains the flexible display panel in a flat state.

Korean Patent Laid-open Publication No. 10-2021-0087604 that is the background of the present invention discloses a back plate based on metal. A back plate made of a metal material that is an electrical conductor absorbs electromagnetic signals, causing a problem in an operation of a handwriting recognition pen. In order to solve this problem, a back plate made of a carbon fiber resin and a carbon fiber reinforced polymer (CFRP) composite material having an electrical insulation property is used, but, due to unique characteristics of the composite material, processing difficulty is very high and thus, a manufacturing process is limited in implementing a fine process. There are problems like that a sanding processing process that is currently used requires a long time and an expensive dry film photoresist (DFR) film is used in the sanding processing process.

### DETAILED DESCRIPTION OF THE INVENTION

### Technical Problem

The present invention provides a back plate for supporting a flexible display panel in which an operational problem of a handwriting recognition pen that is the problem of a back plate based on a metal material according to the related art can be solved, and a method for manufacturing the back plate.

The present invention also provides a back plate for supporting a flexible display panel in which manufacturing cost can be reduced compared to a back plate based on carbon fiber reinforced polymer (CFRP) according to the related art, and a method for manufacturing the back plate.

### Technical Solution

According to an aspect of the present invention, there is provided a back plate for supporting a flexible display panel, the back plate including: a glass plate member having a pore formed therein; two coating layers covering both surfaces of the glass plate member, respectively; and a filling material filled in the pore and connected to the two coating layers, wherein the glass plate member may include two non-deformation structure parts arranged to be spaced apart from each other and a deformation structure part arranged between the two non-deformation structure parts and connecting the two non-deformation structure parts, and the deformation structure part may be formed through a deformation section in the lengthwise direction and may be configured to have a mesh shape by through-holes extending through the deformation structure part along the width direction thereof and forming the pore.

According to another aspect of the present invention, there is provided a method for manufacturing a back plate for supporting a flexible display panel, the method including: a pattern forming operation in which patterns are formed on a glass original plate; a cutting operation in which cutting is performed on the glass original plate according to the patterns so that original plate cutting materials are separated from the glass original plate; a coating operation in which a coating solution is coated onto both surfaces of the original plate coating materials, wherein, in the pattern forming operation, patterns having a mesh shape may be formed through a certain section of a center of the original plate cutting materials in a lengthwise direction, and in the cutting operation, the original plate cutting materials may be separated from each other so that patterns having the mesh shape remain in the center of the original plate cutting materials in the lengthwise direction, and in the coating operation, the coating solution may be filled in a pore of the patterns having a mesh shape.

### Effects of the Invention

According to the present invention, all of the objectives of the present invention described above can be achieved. Specifically, the material of a back plate according to the present invention is based on glass so that an operational problem of a handwriting recognition pen of a back plate based on a metal material according to the related art can be solved.

In addition, the back plate according to the present invention is manufactured by processing glass that has proper hardness compared to carbon fiber reinforced polymer (CFRP) that is a carbon fiber resin composite material having very high processing difficulty and thus is suitable for a sanding process, so that a process time can be reduced and a low cost dry film photoresist (DFR) film can be used and thus manufacturing cost can be reduced.

Furthermore, glass has excellent flatness compared to materials such as a metal material and CFRP and the like, and is the same material as ultra thin glass (UTG) that is window glass for protecting a flexible display panel so that, when glass is used for a back plate for supporting a panel, a screen distortion phenomenon can be minimized. The thermal expansion coefficient of glass is 8.7×10⁻⁷/K, and the thermal expansion coefficient is −0.74×10⁻⁵/K and thus, when the back plate is made of CFRP, due to a distortion phenomenon of a display module caused by a difference in thermal expansion coefficients, a screen distortion phenomenon may occur, whereas, when the back plate is made of a glass material, glass is the same material as cover window glass so that a distortion phenomenon of the flexible display panel due to a difference in thermal expansion rates can be prevented.

On the other hand, in the present invention, a coating layer based on a carbon material having excellent thermal conductivity and a filling material are formed so that heat dissipation and heat diffusion properties can be secured.

### DESCRIPTION OF THE DRAWINGS

FIG. 1 is a schematic diagram illustrating a schematic configuration of a flexible display apparatus to which a back plate for supporting a flexible display panel according to an embodiment of the present invention is applied.

FIG. 2 is a perspective view of the back plate for supporting a flexible display panel according to an embodiment of the present invention shown in FIG. 1.

FIG. 3 is a cross-sectional view of the back plate for supporting a flexible display panel, taken along a line A-A′ of FIG. 2.

FIG. 4 is a plan view illustrating a glass plate member of the back plate for supporting a flexible display panel shown in FIG. 2.

FIG. 5 is a perspective view of a back plate for supporting a flexible display panel according to another embodiment of the present invention.

FIG. 6 is a plan view illustrating a glass plate member of the back plate for supporting a flexible display panel shown in FIG. 5.

FIG. 7 is a flowchart illustrating a method for manufacturing a back plate for supporting a flexible display panel according to an embodiment of the present invention.

FIG. 8 is a diagram schematically describing a state in which a pattern forming operation and a cutting operation of FIG. 7 are performed.

### MODE OF THE INVENTION

Hereinafter, the configuration and operation of embodiments of the present invention will be described in detail with reference to the drawings.

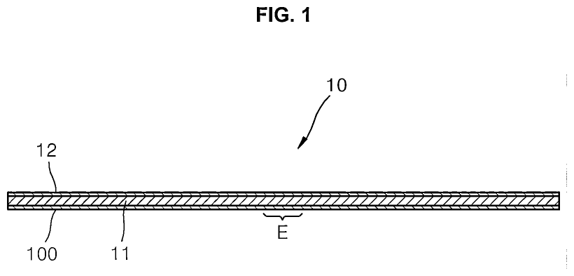

FIG. 1 is a schematic diagram illustrating a schematic configuration of a flexible display apparatus to which a back plate for supporting a flexible display panel according to an embodiment of the present invention is applied, and shows a cross-section structure. Referring to FIG. 1, a flexible display apparatus 10 includes a flexible display panel 11, flexible cover window glass (ultra thin glass: UTG) 12 that is attached to an upper surface of the display panel 11 and protects the display panel 11, and a back plate 100 for supporting a flexible display panel according to an embodiment of the present invention that is attached to a rear surface of the display panel 11 and supports the flexible display panel 111. A bend part is formed through a certain section E in a lengthwise direction in the flexible display apparatus 10 so that the flexible display apparatus 10 is foldable. When the section E in which the bend part is formed, is sufficiently long, the flexible display apparatus 10 may have a rollable shape and thus, this also belongs to the scope of the present invention.

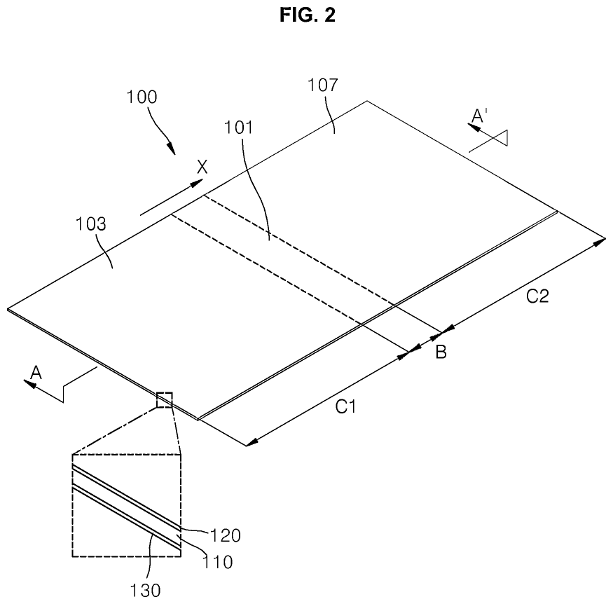

FIG. 2 is a perspective view of the back plate 100 for supporting a flexible display panel according to an embodiment of the present invention shown in FIG. 1. Referring to FIG. 2, the back plate 100 for supporting a flexible display panel (hereinafter, referred to as a ‘back plate’) has an overall generally rectangular plate shape and includes a center layer 110, and a first coating layer 120 and a second coating layer 130 that entirely cover both surfaces of the center layer 110, respectively. The back plate 100 is disposed on a rear surface of the flexible display panel in the flexible display apparatus, supports the flexible display panel entirely and maintains the flexible display panel in a flat state.

The back plate 100 includes a deformation part 101, and a first non-deformation part 103 and a second non-deformation part 107 disposed on both sides of the deformation part 101, respectively, in a plan view. The deformation part 101 is formed through a deformation section B in a lengthwise direction X of the back plate 100 and is positioned between the first non-deformation part 103 and the second non-deformation part 107, which are spaced apart from each other. The deformation part 101 is varied so as to fold and unfold the back plate 100. The first non-deformation part 103 is continuously connected to the deformation part 101 in the lengthwise direction X and is formed through a first non-deformation section C1. The first deformation part 103 is not deformed and maintains a flat plate shape. The second deformation part 107 is continuously connected to the deformation part 101 in the lengthwise direction X and is formed through a second non-deformation section C2. The second non-deformation part 107 is not deformed and maintains a flat plate shape.

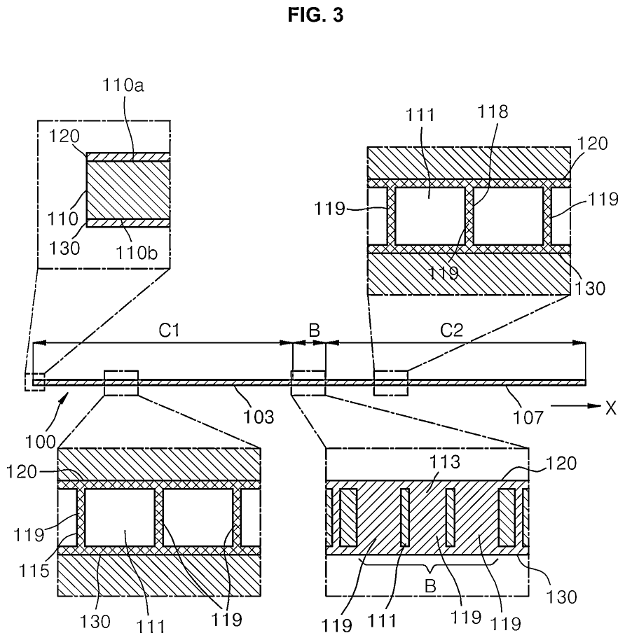

FIG. 3 is a cross-sectional view of the back plate 100. Referring to FIG. 3, the center layer 110 includes a glass plate member 111, and a filling material 119 for filling a pore formed in the glass plate member 111.

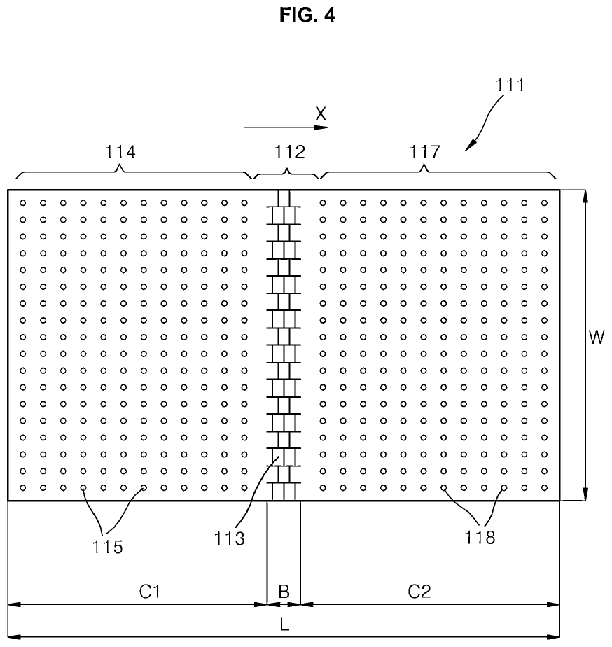

FIG. 4 is a plan view of the glass plate member 111. Referring to FIGS. 3 and 4, the glass plate member 111 has a rectangular planar shape made of a glass material corresponding to the shape of the back plate 100, and includes a deformation structure part 112 formed through the deformation section B, a first non-deformation structure part 114 formed through the first non-deformation section C1, and a second non-deformation structure part 117 formed through the second no-deformation section C2. The deformation section B is a section corresponding to the section E in which a bend part is formed, in FIG. 1. In the present embodiment, the case where the thickness of the glass plate member 111 is about 100 μm, will be described, but the present invention is not limited thereto. Also, in the present embodiment, the case where a length L of the glass plate member 111 having a generally rectangular shape is about 159.2 mm and a width W thereof is about 66 mm, will be described, but the present invention is not limited thereto.

The deformation structure part 112 is formed through the deformation section B in the lengthwise direction X. The deformation structure part 112 is positioned in the center of the glass plate member 111 in the lengthwise direction X. In the present embodiment, the case where the deformation section B in which the deformation structure part 112 is formed, is about 10% of the full length L, will be described, but the present invention is not limited thereto. The deformation structure part 112 forms a bending part so as to fold and unfold the back plate 100. The deformation structure part 112 has a mesh structure. Foldable deformation is possible by the deformation structure part 112 having a mesh structure, and the thickness is not varied. Through holes 113 extending through the deformation structure part 112 in a thickness direction thereof are formed in the deformation structure part 112 by the deformation structure part 112 having a mesh structure. The deformation structure part 112 is useful as a flexible display in that it can minimize a curvature radius as possible when bending, and in the present embodiment, the porosity of the deformation structure 112 by the through holes 113 is preferably 20% to 50%. When the porosity is lower than 20%, it is difficult to secure a desired curvature, and when the porosity is higher than 50%, the possibility that the deformation structure part 112 may be damaged, is increased. The through holes 113 are filled with a filling material 119.

The first non-deformation structure part 114 is formed in the first non-deformation section C1 in the lengthwise direction X. The first non-deformation structure part 114 is continuously connected to the deformation structure part 112. The first non-deformation structure part 114 has a generally flat plate shape, is not deformed and maintains a shape as it is. A plurality of first non-deformation structure part holes 115 are formed in the first non-deformation structure part 114. In the present embodiment, the porosity of the first non-deformation structure part 114 by the plurality of first non-deformation structure part holes 115 is preferably 1.5 to 20%. When the porosity of the first non-deformation structure part 114 is lower than 1.5%, it is difficult to obtain desired thermal performance, and when the porosity is higher than 20%, there is the possibility that the first non-deformation structure part 114 may be deformed. The plurality of first non-deformation structure part holes 115 are filled with the filling material 119.

The second non-deformation structure part 117 is formed through the second non-deformation section C2 in the lengthwise direction X. The second non-deformation structure part 117 is continuously connected to the deformation structure part 112. The second non-deformation structure part 117 has a generally flat plate shape, is not deformed and maintains a shape as it is. A plurality of second non-deformation structure part holes 118 are formed in the second non-deformation structure part 117. In the present embodiment, the porosity of the second non-deformation structure 117 by the plurality of second non-deformation structure part holes 118 is preferably 1.5 to 20%. When the porosity of the second non-deformation structure part 117 is lower than 1.5%, it is difficult to obtain desired thermal performance, and when the porosity is higher than 20%, there is the possibility that the second non-deformation structure part 117 may be deformed. The plurality of second non-deformation structure part holes 118 are filled with the filling material 119.

The filling material 119 is filled in the through holes 113 formed in the deformation structure part 112 of the glass plate member 111, the plurality of first non-deformation structure part holes 115 formed in the first non-deformation structure 114, and the plurality of second non-deformation structure part holes 118 formed in the second non-deformation structure part 117. The filling material 119 is formed integrally with the first coating layer 120 and the second coating layer 130. The filling material 119 is the same material as the first coating layer 120 and the second coating layer 130 and is together formed while two coating layers 120 and 130 are formed.

Referring to FIGS. 2 and 3, the first coating layer 120 covers a first surface 110a (an upper surface in the drawing) of both surfaces of the center layer 110. The first coating layer 120 is formed of a carbon-based resin material and provides high elasticity/high thermal conductivity and an excellent insulation property. The first coting layer 120 is formed by coating a coating solution onto one surface of the glass plate member 111. The first coating layer 120 is formed integrally with the filling material 119 of the center layer 110 and is formed of the same material as the filling material 119. In the present embodiment, the thickness of the first coating layer 120 is 5 μm to 20 μm, will be described.

The second coating layer 130 covers a second surface 110b (a lower surface in the drawing) of both surfaces of the center layer 110. The second coating layer 130 is formed of the same material as the first costing layer 120. The second coating layer 130 is formed by coating the coating solution onto the other surface of the glass plate member 111. The second coating layer 130 is formed integrally with the filling material 119 of the center layer 110 and is formed of the same material s the filling material 119. In the present embodiment, the case where the thickness of the second coating layer 130 is 5 μm to 20 μm, will be described.

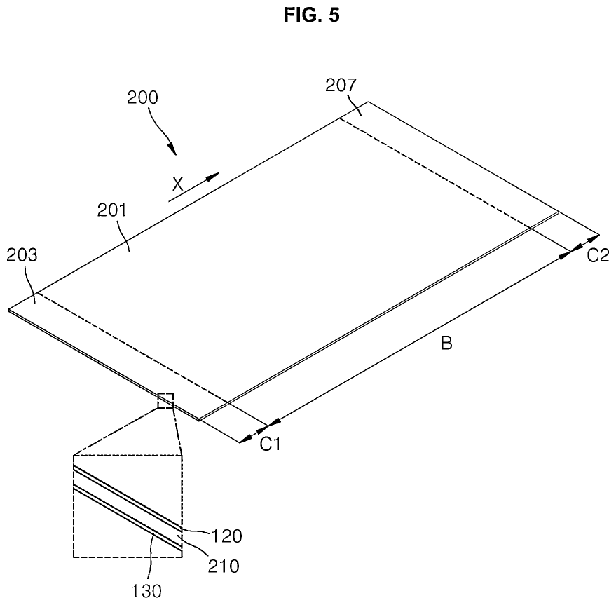

FIG. 5 is a perspective view of a back plate according to another embodiment of the present invention. Referring to FIG. 5, a back plate 200 has an overall generally rectangular plate shape and includes a center layer 210, and a first coating layer 120 and a second coating layer 130, which entirely cover both surfaces of the center layer 210, respectively.

A deformation part 201, and a first non-deformation part 203 and a second non-deformation part 207 positioned at both sides of the deformation part 201, respectively, are formed on the back plate 200. The deformation part 201 is formed through the deformation section B in the lengthwise direction X of the back plate 100, and is positioned between the first non-deformation part 203 and the second non-deformation part 207, which are spaced apart from each other. The deformation part 201 is varied so that the back plate 200 is rollable. The first non-deformation part 203 is continuously connected to the deformation part 201 in the lengthwise direction X and is formed through the first non-deformation section C1. The first non-deformation part 203 is not deformed and maintains a flat plate shape. The second non-deformation part 207 is continuously connected to the deformation part 201 in the lengthwise direction X and is formed through the second non-deformation section C2. The second non-deformation part 207 is not deformed and maintains a flat plate shape.

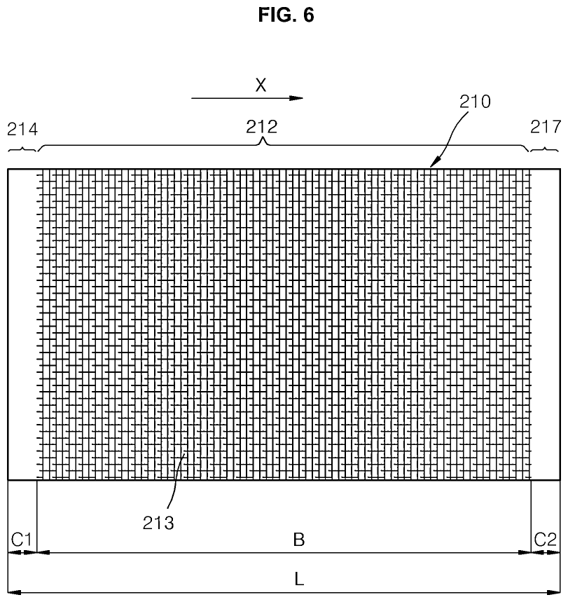

Although not shown, the center layer 210 includes a glass plate member 211 shown in FIG. 6, and a filling material (not shown) for filling a pore 213 formed in the glass plate member 210.

Referring to FIG. 6, the glass plate member 211 has a rectangular planar shape made of a glass material corresponding to the shape of the back plate 200 and includes a deformation structure part 212 formed through the deformation section B, a first non-deformation structure part 214 formed through the first non-deformation section C1, and a second non-deformation structure part 217 formed through the second non-deformation section C2. In the present embodiment, the case where the thickness of the glass plate member 211 is about 100 μm, will be described, but the present invention is not limited thereto. In addition, in the present embodiment, the case where the length L of the glass plate member 211 having a generally rectangular shape is about 159.2 mm and a width W of the glass plate member 211 is about 66 mm, will be described, but the present invention is not limited thereto.

The deformation structure part 212 is formed through the deformation section B in the lengthwise direction X. The deformation structure part 212 is positioned in the center of the glass plate member 211 in the lengthwise direction X. In the present embodiment, the case where the deformation section B in which the deformation structure part 212 is formed, is about 80% of the full length L in consideration of using a rollable shape, will be described, but the present invention is not limited thereto. The deformation structure part 212 forms a rolling part so that the back plate 200 is rollable. The deformation structure part 212 has a mesh structure. Deformation in which the back plate 200 can be rolled and unfolded in a shape of a scroll by the deformation structure part 212 having a mesh structure, is possible. Through holes 213 are formed in the deformation structure part 212 having the mesh shape in a thickness direction. In the present embodiment, the porosity of the deformation structure part 212 through the through holes 213 is preferably 20% to 50%. When the porosity of the deformation structure part 212 is lower than 20%, it is difficult to obtain curvature suitable for rollable, and when the porosity of the deformation structure part 212 is higher than 50%, the possibility that the deformation structure part 212 may be damaged, is increased. The through holes 213 are filled with a filling material (not shown).

The first non-deformation structure part 214 is formed through the first non-deformation section C1 in the lengthwise direction X. The first non-deformation structure part 214 is continuously connected to the deformation structure part 112. The first non-deformation structure part 214 has a generally flat plate shape, is not deformed and maintains a shape as it is.

The second non-deformation structure part 217 is formed through the second non-deformation section C2 in the lengthwise direction X. The second non-deformation structure part 217 is continuously connected to the deformation structure part 212. The second non-deformation structure part 217 has a generally flat plate shape, is not deformed and maintains a shape as it is.

Referring to FIG. 5, the first coating layer 120 covers a first surface (an upper surface in the drawing) of both surfaces of the center layer 210. The first coating layer 120 is the same as the first coating layer 120 in the embodiment shown in FIG. 2.

The second coating layer 130 covers a second surface (a bottom surface in the drawing) of both surfaces of the center layer 210. The second coating layer 130 is the same as the second coating layer 130 in the embodiment shown in FIG. 2.

The first coating layer 120 and the second coating layer 130 are formed integrally with the filling material (not shown) filled in the through holes 213 formed in the deformation structure part 212 in the glass plate member (211 of FIG. 6) of the center layer 210 and is made of the same material as the filling material (not shown). The first coating layer 120 and the second coating layer 130 are connected to each other by the filling material (not shown) in a region of the deformation structure part 212 of the glass plate member 211, and is completely separated from each other in a spaced state in a region of the first non-deformation structure part 214 and the second non-deformation structure part 217.

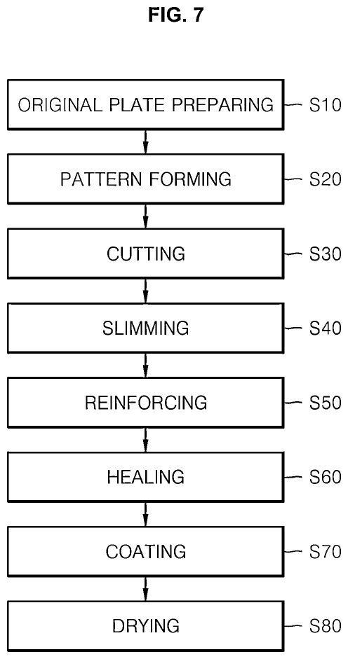

FIG. 7 is a flowchart illustrating a method for manufacturing a back plate for supporting a flexible display panel according to an embodiment of the present invention. The method for manufacturing the back plate shown in FIG. 7 is used to manufacture back plates 100 and 200 having the structure described through FIGS. 2 through 6. Referring to FIG. 7, the method for manufacturing the back plate according to an embodiment of the present invention includes an original plate preparing operation (S10) in which a glass original plate required for manufacturing the back plate is prepared, a pattern forming operation (S20) in which patterns are formed in the glass original plate prepared in the original plate preparing operation (S10), a cutting operation (S30) in which a plurality of original plate cutting materials are separated from the glass original plate formed in the pattern forming operation (S20), a slimming operation (S40) in which the thickness of the original plate cutting materials separated in the cutting operation (S30) is reduced, a reinforcing operation (S50) in which the original plate cutting materials having the thickness reduced through the slimming operation (S40) are reinforced, a healing operation (S60) in which the original plate cutting materials reinforced through the reinforcing operation (S50) are healed, a coating operation (S70) in which a coating solution is coated into the original plate cutting materials are coated with a coating solution, and a drying operation (S80) in which the coating solution is dried.

In the original plate preparing operation (S10), the glass original plate required for manufacturing the glass plate member (111 of FIG. 4) of the back plate (100 of FIG. 2) is prepared. The glass original plate prepared in the original plate preparing operation (S10) has a sufficiently large flat surface size at which the plurality of glass plate members (111 of FIG. 4) can be manufactured from the glass original plate. After the glass original plate is prepared in the original plate preparing operation (S10), the pattern forming operation (S20) is performed.

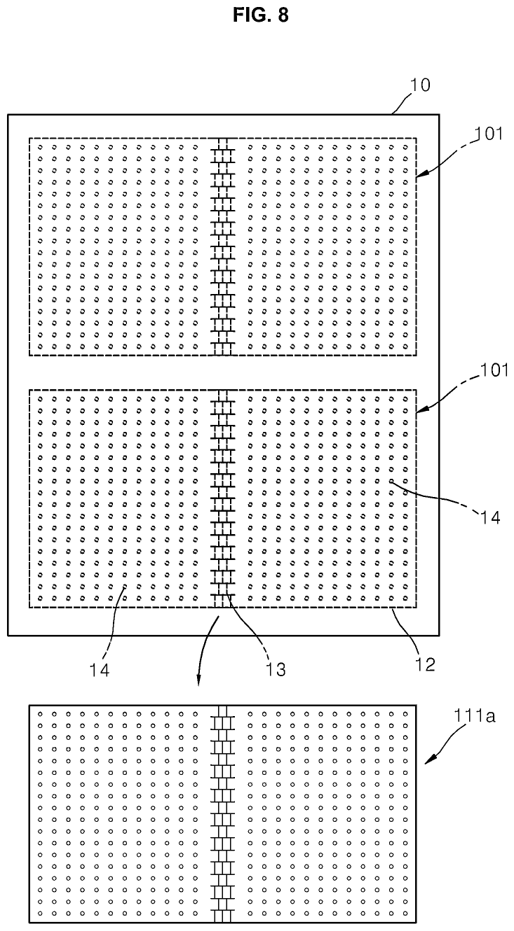

In the pattern forming operation (S20), patterns are formed on the glass original plate prepared through the original plate preparing operation (S10). FIG. 8 illustrates a state in which the pattern forming operation (S20) is performed so that patterns are formed on the glass original plate. Referring to FIG. 8, patterns shown in dashed lines are formed on the glass original plate 10. The patterns formed on the glass original plate 10 include a plurality of unit patterns 101. The unit patterns 101 have a size and a shape corresponding to the glass plate member (111 of FIG. 4). The unit patterns 101 include cutting patterns 12 corresponding to the edge of the glass plate member (111 of FIG. 4), mesh patterns 13 corresponding to the mesh structure of the deformation structure part 112 of the glass plate member (111 of FIG. 4), and hole patterns 14 corresponding to holes 115 and 118 of the glass plate member (111 of FIG. 4). In the present embodiment, the case where the pattern forming operation (S30) is performed so that patterns are formed by attaching a dry film photoresist (DFR) to both surfaces of the glass original plate 10, removing a protective film corresponding to the patterns from the DFR and then performing exposure and development processes, will be descried. After the pattern forming operation (S20) is completed, the cutting operation (S30) is performed.

In the cutting operation S30, cutting of the glass original plate is performed along the patterns formed in the pattern forming operation (S20) so that the plurality of original plate cutting materials are separated from the glass original plate 10. Referring to FIG. 8, the state where the cutting operation (S30) is performed and original plate cutting materials 111a are separated from the glass original plate 10, is shown. In the present embodiment, the case where the cutting operation (S40) is performed using sand blasting, will be described, and the present invention is not limited thereto, and another cutting method such as laser cutting may be used, and this also belongs to the scope of the present invention. After the cutting operation (S30) is performed, the slimming operation (S40) of the original plate cutting materials 111a obtained in the cutting operation (S30) is performed. The CFR attached to the original plate cutting materials 111a is removed before the slimming operation (S40) is performed.

In the slimming operation (S40), the original cutting materials (111a of FIG. 8) separated in the cutting operation (S30) are immersed into an etching solution so that the thickness of the original cutting materials (111a of FIG. 8) is reduced by the etching solution. After the thickness of the original plate cutting materials (111a of FIG. 8) is reduced in the slimming operation (S40), the reinforcing operation (S50) is performed.

In the reinforcing operation (S50), the original plate cutting materials having the thickness reduced in the slimming operation (S40) are chemically reinforced. The reinforcing operation (S50) uses a general method for reinforcing glass and thus, detailed descriptions thereof will be omitted. After the reinforcing operation (S50) is performed, the heating operation (S60) is performed.

In the healing operation (S60), healing of the original plate cutting materials reinforced in the reinforcing operation (S50) is performed. In the healing operation (S60), a grinding process is performed on the surface of the reinforced original plate cutting materials. Since the healing operation (S60) uses a general method of polishing a glass surface, detailed descriptions thereof will be omitted. After the healing operation (S60) is performed, the coating operation is performed.

In the coating operation (S70), a coating solution is coated onto the original plate coating materials. The first and second coating layers 120 and 130 and the filling material (190 of FIG. 3) of the back plate (100 of FIG. 2) are formed by the coating solution coated in the coating operation (S70). In the present embodiment, plasma coating, 3D printing, coating using a bar (roller) coater, coating using a spin coater, spray coating, or slot die coating may be used as a method of coating the coating solution in the coating operation (S70). The coating solution used in the coating operation (S80) includes a carbon material of 5 to 25 wt %, polyvinyl alcohol (PVA) of 0.5 to 3 wt %, graphene of 1 to 3 wt %, carbon nanotube (CNT) of 1 to 3 wt %, water of 25 to 35 w %, and alcohol of 30 to 40 wt %. Carbon, graphene, and CNT enhance a heat dispersion function. PVA serves as an adhesive, a fortifying agent, and a stabilizer. Water and alcohol serve as a solvent. After the coating operation (S70) is performed, the drying operation (S80) is performed.

In the drying operation (S80), the coating solution coated in the coating operation (S70) is dried so that the first and second coating layers 120 and 130 and the filling material (190 of FIG. 3) of the back plate (100 of FIG. 2) can be formed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A back plate for supporting a flexible display panel, the back plate comprising:
a glass plate member having a pore formed therein;
two coating layers covering both surfaces of the glass plate member, respectively; and
a filling material filled in the pore and connected to the two coating layers, wherein the glass plate member comprises two non-deformation structure parts arranged to be spaced apart from each other and a deformation structure part arranged between the two non-deformation structure parts and connecting the two non-deformation structure parts, and
the deformation structure part is formed through a deformation section in the lengthwise direction and is configured to have a mesh shape by through-holes extending through the deformation structure part along the width direction thereof and forming the pore.

2. The back plate of claim 1, wherein porosity of the deformation structure part by the through holes is 20% to 50%.

3. The back plate of claim 1, wherein the filling material is a same material as the coating layer, and the two coating layers are integrally connected to the filling material.

4. The back plate of claim 1, wherein a plurality of non-deformation structure part holes that extend through the two non-deformation structure parts in a thickness direction thereof and form the pore, are formed in the two non-deformation structure parts, respectively.

5. The back plate of claim 4, wherein porosity of the non-deformation structure part by the plurality of non-deformation structure part holes is 1.5% to 20%.

6. The back plate of claim 4, wherein the filling material is a same material as the coating layer, and the two coating layers are integrally connected to the filling material.

7. The back plate of claim 1, wherein a thickness of the coating layer is 5 μm to 20 μm.

8. The back plate of claim 1, wherein the coating layer is made of a carbon-based resin material.

9. A method for manufacturing a back plate for supporting a flexible display panel, the method comprising:
a pattern forming operation in which patterns are formed on a glass original plate;
a cutting operation in which cutting is performed on the glass original plate according to the patterns so that original plate cutting materials are separated from the glass original plate;
a coating operation in which a coating solution is coated onto both surfaces of the original plate coating materials,
wherein, in the pattern forming operation, patterns having a mesh shape are formed through a certain section of a center of the original plate cutting materials in a lengthwise direction, and
in the cutting operation, the original plate cutting materials are separated from each other so that patterns having the mesh shape remain in the center of the original plate cutting materials in the lengthwise direction, and
in the coating operation, the coating solution is filled in a pore of the patterns having a mesh shape.

10. The method of claim 9, wherein, in the pattern forming operation, patterns corresponding to a plurality of holes are together formed in a region of the patterns having the mesh shape, and in the coating operation, the coating solution is filled in the plurality of holes.

11. The method of claim 9, wherein the coating solution comprises a carbon material, a resin material, and water.

12. The method of claim 11, wherein the coating solution further comprises graphene.

13. The method of claim 11, wherein the coating solution further comprises carbon nanotube.

14. The method of claim 9, further comprising a slimming operation in which a thickness of the original plate cutting materials is reduced before the coating operation is performed.
